(19) United States
(12) Patent Application Publication
(10) Pub. No.: US 2007/0294380 A1
(43) Pub. Date: Dec. 20, 2007

(54) System and method for periodic server-to-client data delivery

(75) Inventors: Giri Natarajan, La Palma, CA (US); Silvy Wilson, Rancho Santa Margar., CA (US); William Su, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/452,778

(22) Filed: Jun. 14, 2006

(51) Int. Cl. G06F 15/173

(52) U.S. Cl. 709/223

(57) ABSTRACT

A server-to-client data delivery system and method is provided. The system includes a server capable of providing a variety of services to one or more client devices. Each client device periodically transmits a heartbeat signal to the server over an associated network including client device identification data. When the server fails to receive a heartbeat from an associated client device, an alert signal is generated indicating the non-responsiveness of the associated client device. For each responsive client device, the server performs an identification of the device and determines whether new or updated software, or supplemental data, is available for the client. The server then generates response data including the next heartbeat interval and the software or supplemental data. The response data is then transmitted to the responsive and identified client, whereupon the server proceeds to perform the same process for each responsive and identified client.

### BACKGROUND OF THE INVENTION

The subject application is directed to a system and method for server-to-client data delivery. More particularly, the subject application is directed to a system wherein a client device periodically transmits information or heartbeat data to a server to inform the server that the client is presently accessing the server. In response to such heartbeat data transmission, the server will periodically transmit software, updates, data, or other supplemental information to such client.

In a typical web-based data communication between a client and a server, a server has no information as to presence or availability of a client until such time as the client initiates a request for services to that server. There are frequent requirements to update software, data, drivers, operating systems, and the like on networked workstations. While any workstation requires periodic updates, this is also a requirement in workstations that are used in connection with document processing operations.

In prior, network-based update procedures, it is incumbent on a workstation to inquire as to whether any new, modified or updated software, data, drivers, operating systems, and the like are available on a server. If a server has such information, it cannot determine a presence of a workstation or a need for transmission until it receives information from the workstation first. As such, there is a need for a system and method wherein a client periodically informs the server of its presence on the network.

The subject system seizes upon receipt of a periodic heartbeat pulse to selectively allow for communicating of such new or updated data or executable code to a workstation in need of the same.

### SUMMARY OF THE INVENTION

In accordance with the subject application, there is provided a system and method for server-to-client data delivery.

Further, in accordance with the subject application, there is provided a system wherein a client device periodically transmits information or heartbeat data to a server to inform the server that the client is presently accessing the server, wherein in response to such heartbeat data transmission, the server will periodically transmit software, updates, data, or other supplemental information to such client.

Still further, in accordance with the subject application, there is provided a system and method seizes upon receipt of a periodic heartbeat pulse to selectively allow for communicating of such new or updated data or executable code to a workstation in need of the same.

Still further, in accordance with the subject application, there is provided a server-to-client data delivery system. The system comprises input means adapted for periodically receiving heartbeat data from each of a plurality of associated workstations via a network. The heartbeat data includes identification data representative of an identity of each of the associated workstations. The system also comprises testing means adapted for testing received request data to identify delivery data targeted for at least one of the associated workstation as well as alarm means adapted for generating an alarm signal corresponding to each workstation from which no heartbeat data has been received for a preselected time period. The system also includes means adapted for selectively generating response data responsive to received heartbeat data inclusive of identified delivery data targeted for the at least one associated workstation and means adapted for communicating response data to the at least one associated workstation in accordance with identification data associated therewith.

Still further, in accordance with the subject application, there is provided a server-to-client data delivery method. The method includes the steps of periodically receiving heartbeat data from each of a plurality of associated workstations via a network, wherein the heartbeat data including identification data representative of an identity of each of the associated workstations. The method also comprises the steps of testing received request data to identify delivery data targeted for at least one of the associated workstation and generating an alarm signal corresponding to each workstation from which no heartbeat data has been received for a preselected time period. If delivery data is detected, then the method selectively generates response data responsive to received heartbeat data inclusive of identified delivery data targeted for the at least one associated workstation and communicates response data to the at least one associated workstation in accordance with identification data associated therewith.

In a preferred embodiment, the associated workstation is comprised of a document processing kiosk and the delivery data includes executable code adapted for operation thereof. Preferably, the executable code performs an update of software located on document processing kiosk.

In a preferred embodiment, the system and method further include the ability to communicate a plurality of response data sets to the at least one associated workstation corresponding to a consecutive plurality of received heartbeat data corresponding thereto, such that the at least one workstation receives delivery data in a plurality of segments conjoined at the associated workstation.

Still other advantages, aspects and features of the subject application will become readily apparent to those skilled in the art from the following description wherein there is shown and described a preferred embodiment of the subject application, simply by way of illustration of one of the best modes best suited for to carry out the subject application. As it will be realized, the subject application is capable of other different embodiments and its several details are capable of modifications in various obvious aspects all without departing from the scope of the subject application. Accordingly, the drawing and descriptions will be regarded as illustrative in nature and not as restrictive.

### BRIEF DESCRIPTION OF THE DRAWINGS

The subject application is described with reference to certain figures, including:

FIG. 1 which is an overall system diagram for server-to-client data delivery system according to the subject application;

FIG. 2 is a block diagram illustrating server hardware for use in the system for server-to-client data delivery according to the subject application;

FIG. 3 is a block diagram illustrating workstation hardware for use in the system for server-to-client data delivery according to the subject application;

FIG. 4 is a flowchart illustrating the method for a server-to-client data delivery from a server point of view according to the subject application; and

FIG. 5 is a flowchart illustrating the method for a server-to-client data delivery from a client point of view according to the subject application.

### DETAILED DESCRIPTION OF THE PREFERRED EMBODIMENT

The subject application is directed to a system and method for server-to-client data delivery. In particular, the subject application is directed to a system and method wherein a client device periodically transmits information or heartbeat data to a server to inform the server that the client is presently accessing the server, wherein in response to such heartbeat data transmission, the server will periodically transmit software, updates, data, or other supplemental information to such client. More particularly, the subject application is directed to a system and method that seizes upon receipt of a periodic heartbeat pulse to selectively allow for the communication of new or updated executable code to a workstation in need of the same.

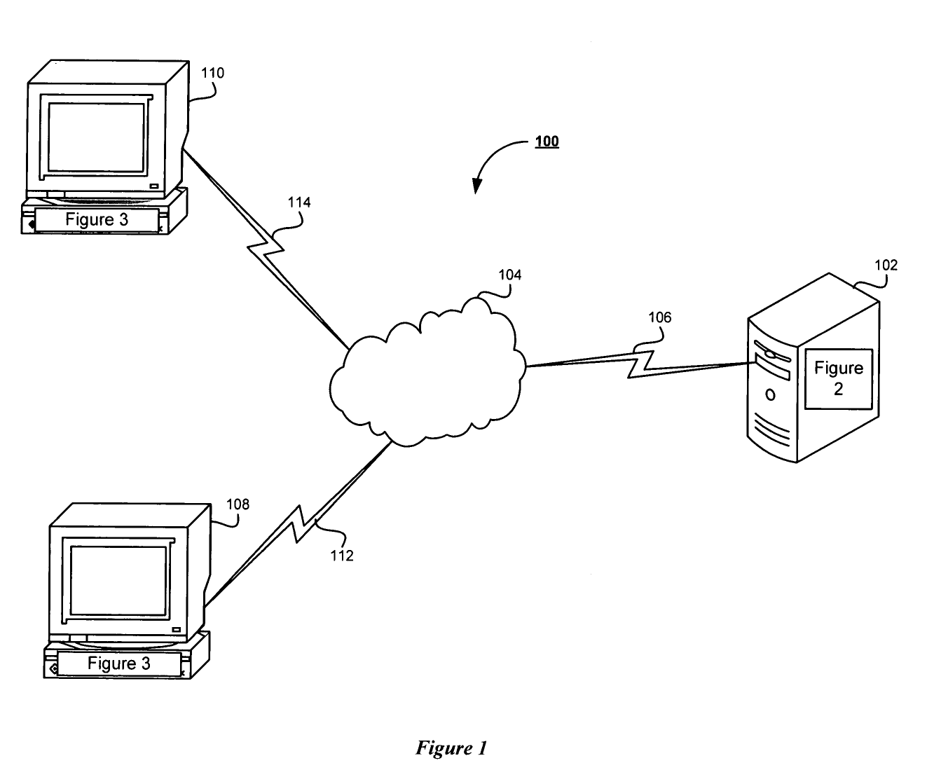

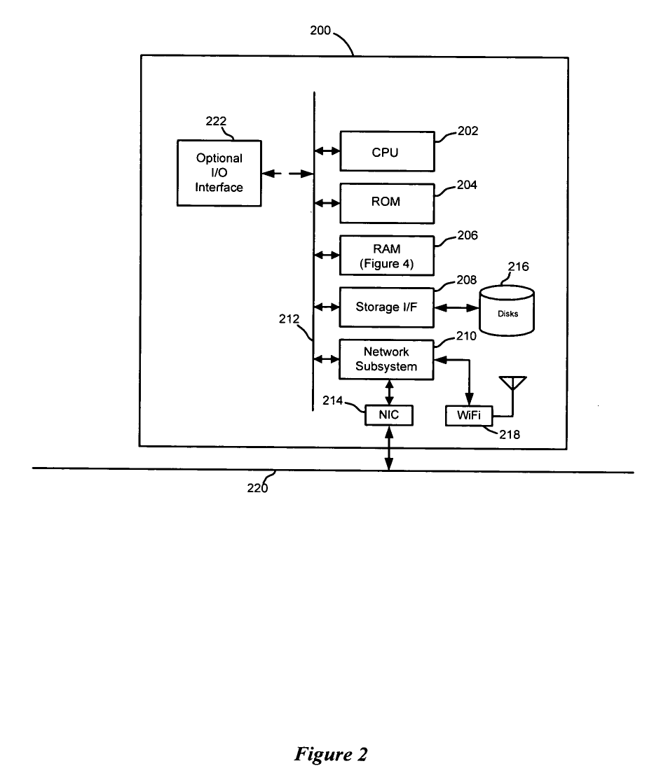

Referring now to FIG. 1, there is shown a block diagram of a system 100 in accordance with the subject application. As shown in FIG. 1, the system 100 includes a server 102 in data communication with a distributed communications environment 104 via a suitable communications link 106. It will be appreciated by those skilled in the art that the server is representative of any computer hardware employed in a server-type role in a client-server relationship. In the preferred embodiment, the server 102 is suitably adapted to provide, or host, a variety of applications and services, which are used by one or more client devices. Preferably, the server 102 is capable of providing a variety of web-based services, including, for example and without limitation, remote access, remote storage, document processing operations, print job generation, electronic mail, document management services, and the like. The functioning of the server 102 will be better understood in conjunction with the block diagram illustrated in FIG. 2 and discussed in greater detail below.

In the preferred embodiment, the distributed communications environment 104 is a computer network, suitably adapted to enable the exchange of data between two or more electronic devices. In accordance with one aspect of the subject application, the network 104 is a distributed network, including, for example and without limitation, the Internet, wide area network, or the like. It will be appreciated by those skilled in the art that suitable networks include, for example and without limitation, a proprietary communications network, a local area network, a personal area network, an intranet, and the like.

Communications between the distributed network 104 and the server 102 are advantageously accomplished using the communications link 106. As will be appreciated by those skilled in the art, the communications link 106 is any data communication medium, known in the art, capable of enabling the exchange of data between two electronic devices. The communications link 106 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

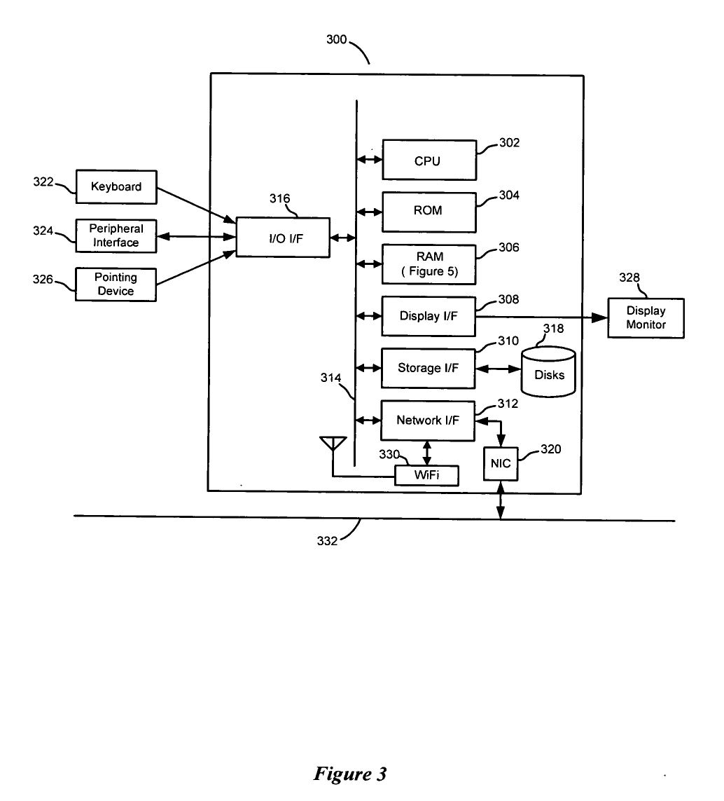

The system 100 also includes a first client device and a second client device, illustrated in FIG. 1 as the first computer workstation 108 and the second computer workstation 110. It will be appreciated by those skilled in the art that the client devices, e.g., first workstation 108 and second workstation 110 are shown in FIG. 1 as computer workstations for example purposes. As the skilled artisan will understand, the workstations 108 and 110 shown in FIG. 1 are representative of any computing device known in the art, including, for example and without limitation, workstation, a document processing kiosk, a personal computer, a personal data assistant, a web-enabled cellular telephone, a smart phone, or other web-enabled electronic device suitably capable of generating and/or transmitting electronic document data to a multifunctional peripheral device. It will be understood by those skilled in the art that the client device, or workstation 108 or 110 is suitably capable of implementation as a controller associated with a document processing device (not shown). The skilled artisan will appreciate that such an embodiment is in accordance with the methodologies and systems described and claimed herein. The functioning of the first computer workstation 108 and the second computer workstation 110 will better be understood in conjunction with the block diagram illustrated in FIG. 3, discussed in greater detail below.

In the preferred embodiment, the workstations 108 and 110 are in data communication with the network 104 via suitable communications links 112 and 114, respectively. As will be understood by those skilled in the art, the communications links 112 and 114 are any suitable communications channels known in the art including, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. In the preferred embodiment of the subject application, the workstations 108 and 110 are advantageously equipped to facilitate the generation of service requests to be performed by the server 102.

Turning now to FIG. 2, illustrated is a representative architecture of a suitable server 200, shown in FIG. 1 as the server 102, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by processor 202.

A storage interface 208 suitably provides a mechanism for volatile, bulk or long term storage of data associated with the server 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the server 200 to communicate to other devices. Network interface subsystem 210 suitably interfaces with one or more connections with external devices to the server 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network subsystem 210 is suitably accomplished via a bus data transfer mechanism, such as illustrated by bus 212.

Suitable executable instructions on the server 200 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 222 as will be appreciated by one of ordinary skill in the art.

Referring now to FIG. 3, illustrated is a hardware diagram of a suitable workstation 300 for use in connection with the subject system 100. The skilled artisan will appreciate that the workstation 300 depicted in FIG. 3 is representative of both the first workstation 108 and the second workstation 110, shown in FIG. 1. A suitable workstation includes a processor unit 302 which is advantageously placed in data communication with read only memory 304, suitably non-volatile read only memory, volatile read only memory or a combination thereof, random access memory 306, display interface 308, storage interface 310, and network interface 312. In a preferred embodiment, interface to the foregoing modules is suitably accomplished via a bus 314.

Read only memory 304 suitably includes firmware, such as static data or fixed instructions, such as BIOS, system functions, configuration data, and other routines used for operation of the workstation 300 via CPU 302.

Random access memory 306 provides a storage area for data and instructions associated with applications and data handling accomplished by processor 302.

Display interface 308 receives data or instructions from other components on bus 314, which data is specific to generating a display to facilitate a user interface. Display interface 308 suitably provides output to a display terminal 326, suitably a video display device such as a monitor, LCD, plasma, or any other suitable visual output device as will be appreciated by one of ordinary skill in the art.

Storage interface 310 suitably provides a mechanism for non-volatile, bulk or long term storage of data or instructions in the workstation 300. Storage interface 310 suitably uses a storage mechanism, such as storage 318, suitably comprised of a disk, tape, CD, DVD, or other relatively higher capacity addressable or serial storage medium.

Network interface 312 suitably communicates to at least one other network interface, shown as network interface 320, such as a network interface card, and wireless network interface 330, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 320 is interconnected for data interchange via a physical network 332, suitably comprised of a local area network, wide area network, or a combination thereof.

An input/output interface 316 in data communication with bus 314 is suitably connected with an input device 322, such as a keyboard or the like. Input/output interface 316 also suitably provides data output to a peripheral interface 324, such as a USB, universal serial bus output, SCSI, Firewire (IEEE 1394) output, or any other interface as may be appropriate for a selected application. Finally, input/output interface 316 is suitably in data communication with a pointing device interface 328 for connection with devices, such as a mouse, light pen, touch screen, or the like. The skilled artisan will appreciate that the use of the workstation 300 herein is for example purposes only. It will be apparent to those skilled in the art that the subject application is capable of incorporating the components described above and the methodologies described below on any myriad of computing devices, including, for example and without limitation, a controller associated with a document processing device, a laptop computer, a personal computer, a personal data assistant, a web-enabled cellular telephone, a proprietary portable electronic communication device, or the like.

In operation, the workstations 108 and 110 routinely, and upon the expiration of a predetermined time period, transmit a heartbeat signal to the server 102 indicating that the workstations 108 and 110 are accessing services provided by the server 102. Preferably, the heartbeat signal sent by the workstations 108 and 110 include data representative of the identity of the sending device, i.e., workstation 108 or workstation 110. When a predetermined period of time has expired, as set by a response from the server 102 to the receipt of the preceding heartbeat signal, the workstation 108 sends a heartbeat signal to the server 102 via the communications network 104. Similarly, the workstation 110 sends a heartbeat signal to the server 102 upon the expiration of a predetermined period of time, as set in the response to the preceding heartbeat signal.

The server 102 routinely receives heartbeat signals from multiple workstations associated with the services provided by the server 102. Preferably, the signals received from each workstation 108 or 110 serve to identify the device from among all devices sending such signals to the server 102. In the event that the server 102 does not receive a heartbeat signal from one of the devices, e.g., workstation 110, the server 102 issues an alert signal indicating the non-responsiveness of the device 110 to an administrator, service log, technical support, or the like.

For each heartbeat signal received from a workstation, the server 102 identifies the originating device, e.g., responsive workstation 108. Based upon this identification, the server 102 determines whether executable code, a software update, upgrade, or other supplemental data, i.e., delivery data, is available for the workstation 108. When no such software is available, the server 102 generates and transmits data representing the next heartbeat transmission interval to the workstation 108. The server 102 then determines if additional clients remain for determination of the availability of updates. When an update is available, the server 102 generates response data including the new or updated software, as well as the next interval for heartbeat transmission, to the workstation 108. When the software is exceptionally large, it is segmented by the server 102 and transmitted in successive responses to heartbeat signals until all such segments have been received by the workstation 108. Following receipt of the entire software update, the workstation 108 installs the new or upgraded software. The workstation 108 then transmits a heartbeat signal upon the expiration of the predetermined period of time, as set by the last response from the server 102. In one particular embodiment, the software is transmitted as executable code, the execution of which installs the updates, new software, upgrades, supplemental data, or the like.

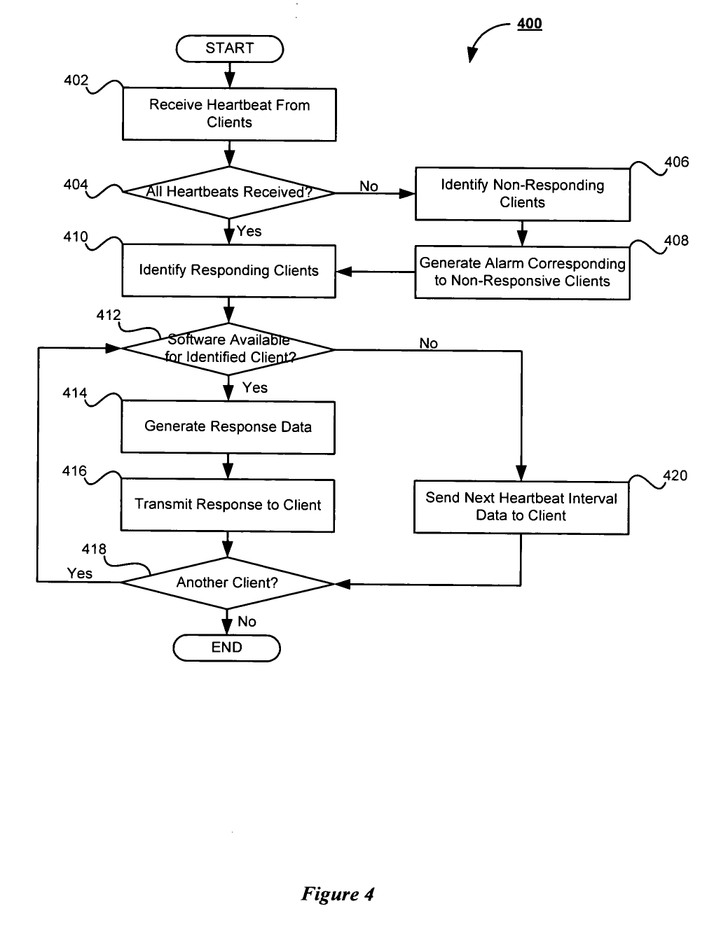

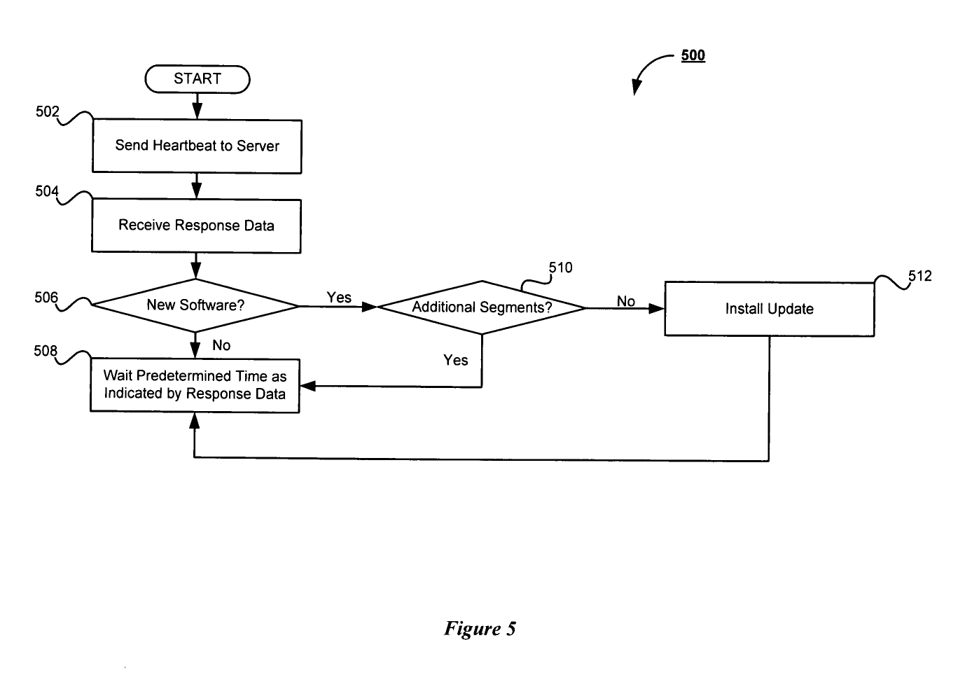

The functioning of the system 100 and the components described above in accordance with FIG. 1, FIG. 2, and FIG. 3 will better be understood in conjunction with the method illustrated in FIG. 4 and FIG. 5. Referring now to FIG. 4, there is shown a server-side view of the server-to-client data delivery method according to the subject application. As shown in FIG. 4, the flowchart 400 illustrates the server-side of operations of the method in accordance with the subject application. Beginning at step 402, the server 102 receives a heartbeat signal from each of a plurality of workstations associated with the services provided by the server 102. As previously discussed, the services provided by the server 102 include, but are not limited to, web-based services, including, for example and without limitation, remote access, security verification services, quota management, remote storage, document processing operations, print job generation, electronic mail, document management services, and the like. In accordance with the preferred embodiment of the subject application, each workstation 108 and 110 are instructed to periodically send a heartbeat signal to the server 102 indicating that the device is accessing the server 102. The period of transmission is predetermined during initial connection of the device to the server 102, set by a response to the heartbeat signal from the server 102, or any other manner known in the art.

The server 102 then determines, at step 404, whether heartbeat signals have been received from all workstations 108 and 110 associated with the server 102. When the server 102 determines that one or more workstations are non-responsive, i.e., failed to transmit a heartbeat signal within the preselected period of time, the server 102 identifies the non-responsive clients at step 406. Following identification, the server 102 generates an alert signal corresponding to each non-responsive device. Flow then proceeds to step 410, whereupon the responsive clients are identified based upon the received heartbeat signals. It will be appreciated by those skilled in the art that a positive determination that all clients have responded at step 404 prompts flow to proceed to the identification of each client at step 410.

After the server 102 has identified each responsive client, operations continue to step 412, whereupon a determination is made whether an update is available for a workstation. Those skilled in the art will appreciate that the update, new software, or supplemental data determination is made for each responsive and identified workstation. When no such update or new software is available for the identified workstation, flow proceeds to step 420, whereupon the next heartbeat transmission time is set and sent to the workstation. A determination is then made at step 418 whether another workstation remains for upgrade determination. When no additional workstations remain, operations terminate as the server 102 awaits the receipt of the next batch of heartbeat signals from the associated workstations to begin the process again at step 402. When additional workstations remain, flow returns to step 412, whereupon the next responsive and identified workstation is analyzed to determine whether an update or upgrade is available for the workstation.

When it is determined, at step 412, that new software is available for the responsive and identified workstation, flow proceeds to step 414, whereupon response data is generated by the server 102 inclusive of the next heartbeat time period, and the update, upgraded software, or executable code for a first workstation. The response data is then transmitted to the first workstation at step 416. It will become apparent to those skilled in the art that in the event that the software is too large for a single “piggy-back” transmission, i.e., attachment to the heartbeat interval setting transmission, the server 102 is capable of segmenting the software into smaller components, which are then transmitted individually or as groups, at subsequent heartbeat intervals to the corresponding workstation, thereby allowing the client to receive the entire update and install following receipt of the last segment. Returning to step 416, following transmission of the response data to the workstation, flow proceeds to step 418, whereupon a determination is made whether another workstation remains for analysis during the current heartbeat time interval. When no additional workstations remain, the operation terminates until the receipt of the next batch of heartbeat signals at step 402. When one or more additional workstations remain, operation returns to the determination step 412 for the next responsive and identified workstation.

Turning now to FIG. 5, there is shown a flowchart 500 illustrating the client side operation in accordance with the subject application. As shown in FIG. 5, the flowchart 300 illustrates the method of generating a heartbeat signal by a workstation and receiving software updates, upgrades, or supplemental data in accordance with the subject application. For purposes of explanation only, reference with respect to FIG. 5 will be explained using the workstation 108. The skilled artisan will appreciate that the method depicted in FIG. 5 is applicable to each device associated with the services provided by the server 102. Beginning at step 502, the workstation 108 generates and transmits a heartbeat signal to the server 102, indicating the identity of the workstation 108, and that the workstation 108 is accessing the server 102 provided services. At step 504, the workstation 104 receives response data. In accordance with the preferred embodiment of the subject application, the response data includes a preselected time period, the expiration of which prompts the generation and transmission of a next heartbeat signal from the workstation 108 to the server 102. In addition, the response data is advantageously capable of including new, updated, or upgraded software, supplemental data, executable code, or other delivery data.

The workstation 108 then determines, at step 506, whether the response data includes new software or supplemental data. When no such software or data is indicated, flow proceeds to step 508, whereupon the workstation 108 waits the preselected period of time, as set by the response data or preset by an administrator, before returning to step 502 and transmitting the next heartbeat signal. When software updates or supplemental data is included in the response data, as determined in step 506, flow proceeds to step 510, whereupon a determination is made whether additional data segments are required for installation of the new software or the supplemental data, or execution of the executable code. When additional segments are required, flow proceeds to step 508, whereupon the workstation 108 waits the preselected period of time before transmitting the next heartbeat signal at step 502. When all segments have been received, or when no additional segments are indicated, flow proceeds to step 512, whereupon the new software is installed on the workstation 108. The workstation 108 then progresses to step 508, whereupon the device 108 waits the preselected period of time before transmitting the next heartbeat signal. The skilled artisan will appreciate that the method described in FIG. 3 is repeated for each responsive workstation associated with the server 102.

The subject application extends to computer programs in the form of source code, object code, code intermediate sources and object code (such as in a partially compiled form), or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A server-to-client data delivery system comprising:
input means adapted for periodically receiving heartbeat data from each of a plurality of associated workstations via a network, the heartbeat data including identification data representative of an identity of each of the associated workstations;
testing means adapted for testing received identification data to identify delivery data targeted for at least one of the associated workstation;
alarm means adapted for generating an alarm signal corresponding to each workstation from which no heartbeat data has been received for a preselected time period;
means adapted for selectively generating response data responsive to received heartbeat data inclusive of identified delivery data targeted for the at least one associated workstation; and
means adapted for communicating response data to the at least one associated workstation in accordance with identification data associated therewith.

2. The server-to-client data delivery system of claim 1 wherein the associated workstation is comprised of a document processing kiosk.

3. The server-to-client data delivery system of claim 2 further comprising means adapted for communicating a plurality of response data sets to the at least one associated workstation corresponding to a consecutive plurality of received heartbeat data corresponding thereto, such that the at least one workstation receives delivery data in a plurality of segments conjoined at the associated workstation.

4. The server-to-client data delivery system of claim 1 wherein the delivery data includes executable code adapted for operation thereof.

5. The server-to-client data delivery system of claim 4 wherein the executable code performs an update of software located on document processing kiosk.

6. A server-to-client data delivery method comprising the steps of:
periodically receiving heartbeat data from each of a plurality of associated workstations via a network, the heartbeat data including identification data representative of an identity of each of the associated workstations;
testing received identification data to identify delivery data targeted for at least one of the associated workstation;
generating an alarm signal corresponding to each workstation from which no heartbeat data has been received for a preselected time period;
selectively generating response data responsive to received heartbeat data inclusive of identified delivery data targeted for the at least one associated workstation; and
communicating response data to the at least one associated workstation in accordance with identification data associated therewith.

7. The server-to-client data delivery method of claim 6 wherein the associated workstation is comprised of a document processing kiosk.

8. The server-to-client data delivery method of claim 7 further comprising the step of communicating a plurality of response data sets to the at least one associated workstation corresponding to a consecutive plurality of received heartbeat data corresponding thereto, such that the at least one workstation receives delivery data in a plurality of segments conjoined at the associated workstation.

9. The server-to-client data delivery method of claim 6 wherein the delivery data includes executable code adapted for operation thereof.

10. The server-to-client data delivery method of claim 9 wherein the executable code performs an update of software located on document processing kiosk.

11. A computer-implemented method for server-to-client data delivery comprising the steps of:
periodically receiving heartbeat data from each of a plurality of associated workstations via a network, the heartbeat data including identification data representative of an identity of each of the associated workstations;
testing received identification data to identify delivery data targeted for at least one of the associated workstation;
generating an alarm signal corresponding to each workstation from which no heartbeat data has been received for a preselected time period;
selectively generating response data responsive to received heartbeat data inclusive of identified delivery data targeted for the at least one associated workstation; and
communicating response data to the at least one associated workstation in accordance with identification data associated therewith.

12. The computer-implemented method for server-to-client data delivery of claim 11 wherein the associated workstation is comprised of a document processing kiosk.

13. The computer-implemented method for server-to-client data delivery of claim 12 further comprising the step of communicating a plurality of response data sets to the at least one associated workstation corresponding to a consecutive plurality of received heartbeat data corresponding thereto, such that the at least one workstation receives delivery data in a plurality of segments conjoined at the associated workstation.

14. The computer-implemented method for server-to-client data delivery of claim 11 wherein the delivery data includes executable code adapted for operation thereof.

15. The computer-implemented method for server-to-client data delivery of claim 14 wherein the executable code performs an update of software located on document processing kiosk.
